(19) United States
(12) Patent Application Publication
(10) Pub. No.: US 2020/0249031 A1
(43) Pub. Date: Aug. 6, 2020

(54) METHOD FOR DETERMINING A POSITION OF A VEHICLE IN A DIGITAL MAP

(71) Applicant: Robert Bosch GmbH, Stuttgart (DE)

(72) Inventor: Marlon Ramon Ewert, Untergruppenbach (DE)

(21) Appl. No.: 16/775,957

(22) Filed: Jan. 29, 2020

(30) Foreign Application Priority Data
Jan. 31, 2019 (DE) 102019201222.1

(51) Int. Cl. G01C 21/30; G01C 21/16

(52) U.S. Cl. CPC G01C 21/30; G05D 1/0088; G01C 21/16

(57) ABSTRACT

A method for determining a position of a vehicle in a digital map, including at least the following: a) determining motion information about the motion of the vehicle, b) determining course information which is characteristic for the course of a stretch of road traveled by the vehicle, using motion information determined in a), and c) matching course information determined in b) to map information which is characteristic for the course of roads stored in a digital map.

### RELATED APPLICATION INFORMATION

The present application claims priority to and the benefit of German patent application no. DE 10 2019 201 222.1, which was filed in Germany on Jan. 31, 2019, the disclosure of which is incorporated herein by reference.

### FIELD OF THE INVENTION

The present invention relates to a method for determining a position of a vehicle in a digital map, a computer program, a machine-readable storage medium as well as a control unit for a vehicle. The invention is particularly suitable for use in connection with highly automated or autonomous driving.

### BACKGROUND INFORMATION

An autonomous vehicle is a vehicle that gets along without a driver. In this context, the vehicle drives autonomously by, for example, independently detecting the course of the road, other road users or obstacles and calculating the appropriate control commands in the vehicle, as well as passing them on to the actuators in the vehicle, whereby the driving course of the vehicle is influenced correctly. In the case of a fully autonomous vehicle, the driver is not involved in the driving.

For autonomous operation, among other things, a vehicle needs a sensor system which is able to ascertain a highly accurate vehicle position, particularly with the aid of navigation satellite data (GPS, GLONASS, BeiDou, Galileo). To that end, currently GNSS (Global Navigation Satellite System) signals are received via a GNSS antenna on the vehicle roof and processed with the aid of a GNSS sensor. In this connection, additionally GNSS correction data may be taken into account to improve the locating results. Particularly advantageous GNSS sensors are what are referred to as motion and position sensors which, using GNSS data, are able to ascertain at least a vehicle position or a vehicle orientation or vehicle movement.

The wheel speeds, the steering angle as well as inertial-sensor data of the vehicle are already being used today, together with GNSS data, in a motion and position sensor to determine the position of the vehicle in space as accurately as possible. Moreover, the motion and position sensor may make data, e.g., highly accurate inertial data like, for instance, yaw-rate data and acceleration data available to other sensors or control units of the vehicle, as well (e.g., for a so-called Safe Stop Function).

### SUMMARY OF THE INVENTION

According to an exemplary embodiment and/or method, a method is provides for determining a (self-)position of a (motor-)vehicle in a digital (road-)map, including at least the following steps:
a) Determining motion information about the motion of the vehicle,
b) Determining course information which is characteristic for the course of a stretch of road traveled by the vehicle, using motion information determined in step a),
c) Matching course information determined in step b) to map information which is characteristic for the course of roads stored in a digital map.

Steps a), b) and c) are usually carried out in the order indicated. The method proposed here advantageously allows the most precise self-localization of the vehicle possible, even if GNSS reception is inadequate or the GNSS system of the vehicle fails. Moreover, the method may advantageously aid in ascertaining an initial position of the vehicle. Specifically, a method is described for precisely determining the position of a vehicle in a highly accurate and/or digital map with the help of (highly accurate) yaw-rate and acceleration data, which may be of a motion and position sensor of the vehicle.

In step a), motion information about the (self-)motion of the vehicle is determined. In so doing, which may be motion data about the motion of the vehicle is ascertained. In particular, the motion information or motion data is determined utilizing at least one sensor of the vehicle. For example, the at least one sensor may be a wheel-speed sensor, a steering-angle sensor and/or an inertial sensor such as, e.g., a yaw-rate sensor and/or acceleration sensor of the vehicle. The sensor may be a (combined) motion and position sensor of the vehicle.

In step b), course information which is characteristic for the course of a stretch of road traveled by the vehicle is determined, using motion information (that is, the) motion information ascertained in step a). Alternatively or cumulatively, a digital course of a stretch of road traveled by the vehicle may be determined in step b). This course may be ascertained using motion information determined in step a) and/or using course information determined in step b). In this context, namely, course information is determined which is characteristic for the course of the stretch of road traveled by the vehicle since the last or (immediately) preceding (successful) position determination (according to the method described here). In particular, step b) may be carried out by a (map-)control unit of the vehicle. To that end, the control unit may receive motion information, like especially yaw-rate data and acceleration data from a sensor of the vehicle.

In step c), course information (that is, the) course information ascertained in step b) is matched to map information that is characteristic for the course of roads stored in a (that is, the) digital (road-)map. If a digital course of a stretch of road traveled by the vehicle is determined in step b), in step c), the course ascertained in step b) may be matched to map information that is characteristic for the course of roads stored in the digital map. As a rule, the map information is map data of the digital (road-)map. In particular, this map data describes courses of roads stored in the map. In step c), specifically the (self-)position of the vehicle is determined by matching course information ascertained in step b) to map information that is characteristic for the course of roads stored in a digital (road-)map. In particular, step c) may be carried out by a (map-)control unit of the vehicle.

In the method, information characteristic for the course of the road section used at the moment by the vehicle (e.g., a characteristic sequence of road-bending angles) may be ascertained especially from inertial data like, e.g., yaw-rate data and/or acceleration data, in order to subsequently determine the position of the traveled road section in the map by matching this information to an electronic map (map matching).

According to one advantageous development, the motion information ascertained in step a) is produced using at least one of the following data sources: yaw-rate sensor, acceleration sensor or velocity sensor of the vehicle. In other words, this means, namely, that the motion information determined in step a) includes yaw-rate data, acceleration data and/or velocity data and/or path information of the vehicle.

With the help of the method, the position of the vehicle is able to be fixed extremely precisely in a highly accurate map over time, without necessarily having to determine a GNSS position in do doing. For instance, the method is also usable when an existing GNSS communication is not available, e.g., because of a solar storm (fallback). For example, the method may be carried out particularly when highly accurate acceleration signals and yaw-rate signals from at least one sensor are available in a vehicle, as well as a vehicle velocity over time. Put another way, this means, namely, that acceleration signals and yaw-rate signals may be ascertained in step a) with the aid of at least one sensor of the vehicle and/or may be read in by the (map-)control unit of the vehicle.

One particularly advantageous aspect of the method may be seen in using primarily the yaw-rate data and acceleration data of a motion and position sensor of a vehicle for the precise and/or initial determination of the position of a vehicle in a highly accurate map. To that end, for example, highly accurate yaw-rate data and acceleration data from the motion and position sensor may be passed on to a control unit (additional and/or separate from the motion and position sensor), e.g., via a vehicle data bus. A highly accurate map of the world with all known roads is located in the control unit, which may be a map control unit.

With the help of what may be an intelligent algorithm like, e.g., an (artificial) neural network which may be implemented as artificial intelligence, for example, changes in yaw rate and/or changes in acceleration over time may now be matched very quickly to a specific road on the map. For instance, a (specific) number of road-bending occurrences may be stored temporarily within the control unit and/or the (highly accurate) changes in yaw rate over time may be converted via integration processes into (highly accurate) bending angles. Moreover, the time between the bending occurrences may be used, e.g., together with the GNSS velocity from the motion and position sensor and/or the wheel speeds of the vehicle and/or a vehicle velocity, to (highly accurately) determine the length of road sections between two bending occurrences.

Advantageously, with the help of the change in yaw rate or change in acceleration or the (highly accurately) determined bending angle and the length of a road section between the bending occurrences, the position of the vehicle in the world may be determined (highly accurately) after a few bending occurrences (even in the event of a failure of GNSS communication). In particular, a contributing factor to this is that, as a rule, the angles of road sections invariably differ from each other. Because, for example, four or five bending occurrences as well as the associated bending angles and the road sections lying in between and their length are determined (highly accurately), matching to known roads on the (highly accurate) map may be carried out, for example, using the artificial intelligence like, for instance, the neural network, and thus the position of the vehicle in the world may be determined (highly accurately).

According to one advantageous specific embodiment, the position of the vehicle in the world may be determined (highly accurately) upon starting the vehicle with the aid of the method proposed. This may take place even before a GNSS position fix is available, that is, as soon as the vehicle is on its way. In this connection, it may especially be provided that the search area in the map is limited by using at least one piece of additional information about the position of the vehicle.

According to a further advantageous refinement, the course of a stretch of road traveled at the moment by the vehicle is tracked until the position of the course in the map may be determined (unambiguously) by matching the course to courses of roads stored in the map. Put another way, this means, namely, that the course of the traveled stretch of road, that is, the associated track information is (always) traced (especially stored temporarily) until the course or the course information is sufficiently detailed to allow a (clear) identification of the position of this course (of the stretch of road presently or most recently traveled by the vehicle), that is, of the associated road course, in the map. In this context, the stretch of road traveled at the moment by the vehicle may pertain particularly to the road section which the vehicle has covered since the last successful position determination according to the method presented here.

According to another advantageous embodiment, the motion information ascertained in step a), particularly concerning a (certain) number of bending occurrences, includes the distance(s) between successive bending occurrences and/or at least one bending angle. The motion information may include at least the bending angles of two bending occurrences immediately in succession and the distance between the two successive bending occurrences. Alternatively or cumulatively, the motion information may include at least the respective distance (or the two distances) between three successive bending occurrences and the bending angle with respect to at least the second of the three successive bending occurrences. For example, the bending angles may be determined with the aid of yaw-rate data, that is, by the use of at least one yaw-rate sensor and/or steering-angle sensor of the vehicle. For instance, the distances may be determined based on the time elapsed between the bending occurrences and the vehicle velocity during this time(-period). In this context, the vehicle velocity may be determined, e.g., utilizing at least one wheel-speed sensor, GNSS sensor or acceleration sensor.

According to a further advantageous development, the matching in step c) is carried out utilizing an at least self-learning or machine-learned algorithm. The self-learning and/or machine-learned algorithm may be a self-learning and/or machine-learned search algorithm. This algorithm may be an artificial neural network. For example, inputs into this neural network may be map data of the digital (road-)map as well as motion data such as yaw-rate data, acceleration data and/or velocity data of the vehicle. In addition, the neural network may be equipped to output a position on the digital map. The algorithm may be stored in a (map-)control unit for the vehicle.

According to a further advantageous development, a search area in the map is limited (a priori) using at least one piece of additional information about the (rough or approximate) position of the vehicle. Advantageously, this may help to accelerate the method or enable the method to be carried out even more rapidly, since the possible roads may already be limited to a specific area on the map. Alternatively or cumulatively, from an ambiguous result of the matching according to step c), it is possible to determine an unambiguous result by utilizing at least one piece of additional information about the position of the vehicle.

For example, the additional information may be at least one object and/or environmental feature in the environment of the vehicle detected, e.g., by a driving environment sensor system of the vehicle. In this connection, as additional information, it may also be detected whether the vehicle is in an urban or densely built-up area. For instance, the driving environment sensor system may include a camera, a RADAR sensor, a LIDAR sensor and/or an ultrasonic sensor.

Alternatively or cumulatively, a communication link may be set up to a cellular network (e.g., via car-to-X), and from that, a position of the vehicle may be roughly determined, e.g., via cell tracking. For instance, the data necessary for this may be received via a car-to-X communication. Car-to-car communication (or Car2Car or C2C, for short) is understood to be the exchange of information and data between (motor-)vehicles. The aim of this data exchange is to inform the driver about critical and dangerous situations early on. The vehicles concerned collect data such as ABS interventions, steering angle, position, direction and velocity, and transmit this data via radio (WLAN, UMTS, etc.) to the other road users. In so doing, the intention is to extend the “visual range” of the driver with an electronic arrangement (apparatus/device). Car-to-infrastructure (or C2I, for short) communication is understood to be the exchange of data between a vehicle and the surrounding infrastructure (e.g., traffic lights). The technologies cited are based on the interaction of sensors of the various traffic partners, and employ the latest methods of communication technology for the exchange of this information. In this context, car-to-X is an umbrella term for the various communication links such as car-to-car and car-to-infrastructure.

Elevation data may also be used as additional information. In this connection, according to a further specific embodiment, in addition to the input variables such as, in particular, yaw-rate data and acceleration data mentioned, elevation data may also be taken into account in the (map-)control unit. For instance, this elevation data may be determined from a rough locating of the vehicle via a car-to-X communication (e.g., by measuring the propagation time of the car-to-X signals). Moreover, the elevation may be determined roughly via a pressure sensor within the vehicle, especially within the motion and position sensor, or via a further control unit. This advantageously allows the possible road sections to be limited considerably during the matching on the (highly accurate) digital map.

According to a further advantageous refinement, in addition, feature information from a digital feature map is also drawn upon to determine the position of the vehicle. As a rule, positions and characteristics of environmental features are stored in the digital feature map. On the other hand, the courses of roads are usually stored in digital roadmaps. Maps in which feature maps and roadmaps are combined with each other are also conceivable. In this respect, it may be provided that feature information is used to (a priori) limit the search area in the (road-)map and/or to determine an unambiguous result from an ambiguous result of the matching according to step c). Put another way, this means, namely, that the feature information may also represent additional information in the sense described above.

In a further specific embodiment, it is proposed in particular that the method described here for determining position (with the help of the bending occurrences and road sections) be combined with localization of the vehicle based on a feature map. In this context, by using several bending occurrences, for example, a possible position of the vehicle within the world (in the digital roadmap) may be determined, and at the same time, utilizing features in a feature map, it is possible to check whether the vehicle is actually at this position. In this way, possible redundant positions of a vehicle on a (highly accurate) (road-)map may be limited considerably once again in advantageous manner, e.g., after one or two bending occurrences, with the aid of features existing in the environment. Notably, the method described here for determining position may again be markedly accelerated in this way.

In summary, this may also be described to the effect that in this specific embodiment, the position of the vehicle may be determined especially advantageously in a highly accurate manner and as quickly as possible both with the aid of features and with the aid of road sections and/or bending occurrences. In so doing, an intelligent algorithm like, e.g., a search tree or a neural network may be employed. If no GNSS-based position is available in the vehicle, this specific embodiment offers the advantage of a very rapid determination of position on a (highly accurate) map with only a few bending occurrences, since the possible positions may be limited substantially with the aid of the existing features from the environment (detected by driving-environment sensors of the vehicle).

For example, without being able to draw upon feature information from a feature map, the method described here for determining position may require, e.g., approximately five bending occurrences for locating and determining the position of the vehicle on the map. In contrast, utilizing the specific embodiment with access to a feature map, for example, the position of the vehicle in the world may already be determined highly accurately after one to three bending occurrences.

If the method is combined with a feature map, a position determination based on a feature map may also be accelerated once again in advantageous manner. The position determination based on a feature map may thus advantageously be markedly improved with the aid of the method.

In this connection, for example, it may be provided in particular that the method described be used for determining a position of a vehicle in a digital feature map or a digital combined feature and roadmap. Also in this regard, in step c), course information ascertained in step b) may be matched to map information which is characteristic for the course of roads stored in a digital (road-)map (or possibly the combined feature- and roadmap). In this respect, it is also conceivable that in step c), the (self-)position of the vehicle is determined by matching course information determined in step b) to map information that is characteristic for the course of roads stored in a digital (road-)map. In this context, the matching or ascertainment of the position with the (road-)map may help in particular, for example, to accelerate the position determination based on the feature map, as the match or the position in the (road-)map is used to limit the search area in the feature map and/or to check the plausibility of the position in the feature map and/or to “resolve the ambiguity” of a possibly ambiguous position result.

In a further specific embodiment, the method described may be used in combination with an already (highly accurately) determined GNSS-based position of the vehicle in the world, in order to even more precisely determine the vehicle position on the map. For example, an existing GNSS-based position may be checked for plausibility with the aid of the additionally determined position, utilizing the method. In this connection, for example, in the event of a greater deviation of the GNSS position which may exist, e.g., because of environmental influences or multipath, the position determined using the method proposed here may be employed to nevertheless navigate the (autonomous) vehicle safely through the environment. In addition, it is conceivable to combine the vehicle position determined (highly accurately) from the GNSS, and the method proposed here to form an overall vehicle position (fusion).

In another specific embodiment, the method may also be carried out within at least partially restricted spaces such as tunnels or parking garages, in which there is usually no GNSS reception. Provided the parking garages and tunnels are present within the (highly accurate) digital map (in terms of geometry, parking spaces and levels), it is possible to fix the position of the vehicle highly accurately indoors, as well. A combination with features from a feature map is also possible in this regard, in order to accelerate the method.

According to a further aspect, a computer program is proposed for carrying out a method presented here. In other words, it relates particularly to a computer program (product), including commands which, upon execution of the program by a computer, causes it to carry out a method described here.

According to another aspect, a machine-readable storage medium is proposed, on which the computer program proposed here is stored. The machine-readable storage medium is usually a computer-readable data carrier.

According to a further aspect, a control unit for a vehicle is also proposed, the control unit being equipped to carry out a method proposed here. To that end, the control unit may include a machine-readable storage medium, for example, on which a computer program is stored for carrying out the method. By way of example, the control unit may also include a processor which is able to access the machine-readable storage medium and execute the program. The control unit may be a map control unit. In particular, a digital (road-)map is stored in it.

Moreover, a (motor-)vehicle may also be indicated, including a control unit proposed here. In addition, the vehicle may include a motion and position sensor, for example. In this context, the motion and position sensor and the control unit may be connected to each other in such a way that at least yaw-rate data and/or acceleration data may be transmitted from the motion and position sensor to the control unit. For example, the vehicle may be a (motor-)vehicle which is equipped for highly automated and/or autonomous operation, especially an autonomous automobile.

The motion and position sensor may be a GNSS sensor. The motion and position sensor may be a position and orientation sensor. In addition, the GNSS sensor may take the form of a GNSS-based position and orientation sensor. GNSS sensors or (vehicle-) motion and position sensors are needed for automated or autonomous driving, and calculate a highly accurate vehicle position with the aid of navigation satellite data (GPS, GLONASS, BeiDou, Galileo), which is also referred to as navigation satellite system data. The calculation is based essentially on a measurement of the propagation time of the (electromagnetic) GNSS signals from at least four satellites. Moreover, correction data from what are referred to as correction services may also be used in the sensor to calculate the position of the vehicle even more precisely. Together with the received GNSS data, a highly accurate time (such as universal time) is also read in at regular intervals in the sensor and used for the exact determination of position. Further input data into the position sensor may be wheel speeds, steering angle, as well as acceleration and yaw-rate data. The motion and position sensor may be equipped to ascertain a self-position, self-orientation and self-velocity on the basis of GNSS data.

The details, features and advantageous refinements discussed in connection with the method may also exist correspondingly in the case of the computer program, the storage medium, and the control unit presented here and vice versa. In this respect, reference is made fully to the explanations there for further characterization of the features.

The approach presented here as well as its technical sphere are explained in greater detail hereinafter with reference to the figures. It should be pointed out that the invention is not intended to be limited by the exemplary embodiments indicated. In particular, insofar as not explicitly expressed otherwise, it is also possible to extract partial aspects of the facts illustrated in the figures and combine them with other constituents and/or information from other figures and/or from the present description.

### BRIEF DESCRIPTION OF THE DRAWINGS

FIG. 1 shows a functional sequence of a method presented here.

FIG. 2 shows a vehicle having a control unit presented here.

### DETAILED DESCRIPTION

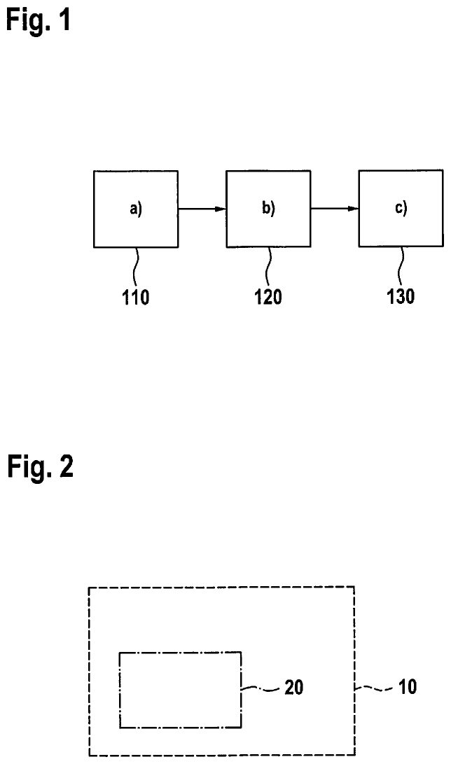

FIG. 1 shows schematically a functional sequence of a method presented here. The method is used to determine a position of a vehicle in a digital map. The order of method steps a), b) and c) represented by blocks 110, 120 and 130 is obtained during a regular operating sequence of the method.

In block 110, according to step a), motion information about the motion of the vehicle is determined. In block 120, according to step b), course information which is characteristic for the course of a stretch of road traveled by the vehicle is determined, using motion information ascertained in step a). In block 130, according to step c), course information determined in step b) is matched to map information which is characteristic for the course of roads stored in a digital map.

FIG. 2 shows schematically a vehicle 10 having a control unit 20 presented here. Control unit 20 is equipped to carry out the method described here.

Notably, the method described affords one or more of the following advantages:
A highly accurate position of an autonomous vehicle may be determined on a highly accurate map based purely on road-bending occurrences and road sections between the bending occurrences.
The position determination may also be used as a fallback solution, for example, in the event of a failure of GNSS.
GNSS positions or positions based on a feature map may also be checked for plausibility with the aid of the method.
In addition, an improved GNSS position determination in the world is conceivable, since an initial position of a vehicle in the world may possibly already be calculated prior to a GNSS fix.
In combination with a feature map available in the vehicle, the method may be used for a very rapid, highly accurate determination of the position of the vehicle in the environment.
Because an alternative, additional and/or redundant position determination is carried out in an autonomous vehicle with the aid of the method, safety and reliability increase during operation of autonomous vehicles.

What is claimed is:

1. A method for determining a position of a vehicle in a digital map, the method comprising:
a) determining motion information about the motion of the vehicle;
b) determining course information which is characteristic for the course of a stretch of road traveled by the vehicle, using motion information determined in a); and
c) matching course information determined in b) to map information which is characteristic for the course of roads stored in a digital map.

2. The method of claim 1, wherein the motion information determined in a) is produced using at least one of the following data sources: yaw-rate sensor, acceleration sensor or velocity sensor of the vehicle.

3. The method of claim 1, wherein the course of a stretch of road traveled at the moment by the vehicle is tracked until the position of the course in the map is determinable by matching the course to courses of roads stored in the map.

4. The method of claim 1, wherein the motion information determined in a) includes at least a distance between successive road-bending occurrences, or at least one bending angle.

5. The method of claim 1, wherein the matching in c) is carried out with an at least self-learning or machine-learned algorithm.

6. The method of claim 1, wherein a search area in the map is limited, using at least one piece of additional information about the position of the vehicle.

7. The method of claim 1, wherein feature information from a digital feature map is drawn upon to determine the position of the vehicle.

8. A non-transitory computer readable medium computer program, which is executable by a processor, comprising:
a program code arrangement having program code for determining a position of a vehicle in a digital map, by performing the following:
a) determining motion information about the motion of the vehicle;
b) determining course information which is characteristic for the course of a stretch of road traveled by the vehicle, using motion information determined in a); and
c) matching course information determined in b) to map information which is characteristic for the course of roads stored in a digital map.

9. The computer readable medium of claim 8, wherein the motion information determined in a) is produced using at least one of the following data sources: a yaw-rate sensor, an acceleration sensor and/or a velocity sensor of the vehicle.

10. A control device for determining a position of a vehicle in a digital map, comprising:
a control unit configured to perform the following:
a) determining motion information about the motion of the vehicle;
b) determining course information which is characteristic for the course of a stretch of road traveled by the vehicle, using motion information determined in a); and
c) matching course information determined in b) to map information which is characteristic for the course of roads stored in a digital map.
